(19) United States
(12) Patent Application Publication
(10) Pub. No.: US 2011/0107998 A1
(43) Pub. Date: May 12, 2011

(54) Engine With Variable Compression Ratio

(76) Inventors: Zhijiang Xiong, Wuhu (CN); Nengcai Lu, Wuhu (CN)

(21) Appl. No.: 13/003,444

(22) PCT Filed: Jul. 7, 2009
(86) PCT No.: PCT/CN2009/072661

§ 371 Date: Jan. 10, 2011

(30) Foreign Application Priority Data
Jul. 29, 2008 (CN) 200810142704.7

(51) Int. Cl. F02B 75/04; F02D 15/04

(52) U.S. Cl. 123/197.4

(57) ABSTRACT

The present invention provides an engine with variable compression ration comprising a cylinder cover, a cylinder body, a power output shaft and a crankshaft box, the cylinder cover is fixed on the cylinder body, the crankshaft box is formed with the cylinder body integrally; In the cylinder body, an piston is connected with a crankshaft via a connecting rod; the power output shaft is mounted on the crankshaft box; a power output gear is placed on the power output shaft, an input gear is placed on a crank journal of the crankshaft, the power output gear engages with the input gear; A supporting arm is placed in the crankshaft box, the crankshaft is hinged on the supporting arm; one end of the supporting arm is hinged on the crankshaft box, and the hinging shaft is the power output shaft; the other end of the supporting arm is a control end, the control end is connected with a rotation control mechanism, which can make the supporting arm rotate around the power output shaft. Since the rotation control mechanism is used to make displacement control over the control end of the supporting arm, the compression ratio of engine matches the engine behavior, so that the efficiency is improved while the emission is reduced.

### FIELD OF THE INVENTION

The present invention relates to an automotive engine, in particular to an engine with variable and controllable compression ratio, which pertains to the technical field of machinery manufacture.

### DESCRIPTION OF THE PRIOR ART

At present, most of engines have immutable compression ratios. However, in order to achieve different purposes, such as, reducing fuel consumption, improving engine performance and reducing emission under different operating conditions, it is necessary to flexibly change the compression ratios of engines according to different operating conditions. In addition, the current flexible-fuel engines are unable to adapt to the different combustion characteristics of different fuels due to the constant compression ratio of the engines thereof. For examples, when an engine is refilled with a different fuel, the thermal efficiency of the engine is reduced, and abnormal combustion phenomena, including knocking, can easily occur; switching to a different fuel in the process of driving may also easily results in unstable operation of the engine and other abnormal phenomenon. Therefore, research on engines with variable compression ratio is emerging as a new research direction in this field. For an example, in the patent documentation with application number of 88101975.5 discloses a device for changing the compression ratio of an internal combustion engine based on variable connecting rod length. However, the change in the compression ratio of internal combustion engine results from the change in the length of connecting rod, which is caused by deformation of the spring under stress exerted thereupon, and which is completed during the multiple strokes of the internal combustion engine, such a change in the compression ratio is uncontrollable, therefore the patent documentation with application number of 88101975.5 is unable to provide the flexible-fuel engine with the compression rations that are adaptable to different fuels.

### SUMMARY OF THE INVENTION

To overcome the deficiencies of the prior art, the present invention provides an engine with variable compression ratio, wherein the compression ratio of such engine is changed based on controllable structural change of the engine.

The technical objective of the present invention is achieved by adopting the following technical solution:

The present invention is to provide an engine with variable compression ratio comprising a cylinder cover, a cylinder body, a power output shaft and a crankshaft box, wherein, the cylinder cover is fixed on the cylinder body, the crankshaft box is formed integrally with the cylinder body; In the interior of the cylinder body, an piston is coupled with a crankshaft via a connecting rod; The power output shaft is mounted on the crankshaft box and is provided with a power output gear, which engages with an input gear provided on a crank journal of the crankshaft; A supporting arm, upon which the crankshaft is hinged is provided in the crankshaft box; One end of the supporting arm is hinged onto the crankshaft box with the power output shaft as the hinging shaft is; the other end of the supporting arm is a control end connected with a rotation control mechanism, which enables the supporting arm rotate around the power output shaft.

The engine with variable compression ratio of the present invention is divided into two parts, namely, an upper part comprising a cylinder cover and a lower part comprising a cylinder body and a crankshaft box. The upper part remains unchangeable, in the lower part, based on the principle of lever; a supporting arm is used to adjust the position of the crankshaft center. Specifically, under the control of the controlling mechanism, the supporting arm rotates around the position where the supporting arm is hinged onto the cylinder body so as to realize a small displacement of the crankshaft center position relative to the cylinder body, and as a result, the position of the top dead point of the engine is changed, and the compression ratio of engine also is changed accordingly. Thanks to the controlling mechanism, the compression ratio of such an engine with variable compression ratio is controllable, and it is feasible to realize the compression ratios that are best adapted to the various operating conditions.

As a further improved solution of the present invention, said controlling mechanism comprises a control motor, a control motor gear, an eccentric shaft, a sliding block and an eccentric shaft gear. The control motor gear is mounted on the sliding block; the eccentric shaft gear is mounted on the center line at one end of the eccentric shaft and always engages with the control motor gear. A sliding block is connected onto the center line at the other end of eccentric shaft; the control end of the supporting arm is hinged on the offset-center line of eccentric shaft.

Designed based on the principle of eccentric action, the controlling mechanism uses the control motor to drive the rotation of eccentric shaft. As a result, the control end of the supporting arm can make up and down movement so as to realize the slight displacement of the crankshaft center position relative to the cylinder body and the change in the compression ratio of engine. For engines adopting such technical solution, when it is necessary, the compression ratio may be varied through manipulating the control motor to drive the rotation of eccentric shaft so as to change the distance between the crankshaft center and the cylinder body. As a result, based on such adapted compression ratios corresponding to different operating conditions, the optimal fuel economy and dynamic performance of the engine may be achieved.

The preferred embodiments of the present invention will be described below in details with reference to the attached drawings.

### BRIEF DESCRIPTION OF THE DRAWINGS

FIG. 1 is an overall structural diagram of the present invention;

FIG. 2 is an A-direction partial view in FIG. 1;

FIG. 3 and FIG. 4 respectively illustrates the structural diagram and the schematic diagram of the present invention.

### DESCRIPTION OF THE MARKS IN THE ATTACHED DRAWING

1—cylinder body, 2—piston, 3—connecting rod, 4—supporting arm, 5—eccentric shaft, 6—sliding block, 7—control motor gear, 8—eccentric shaft gear, 9—crankshaft, 10—input gear, 11—output gear, 12—power output shaft, 13—motor shaft, 100—end face of combustor.

### DETAILED DESCRIPTION OF THE PREFERRED EMBODIMENTS

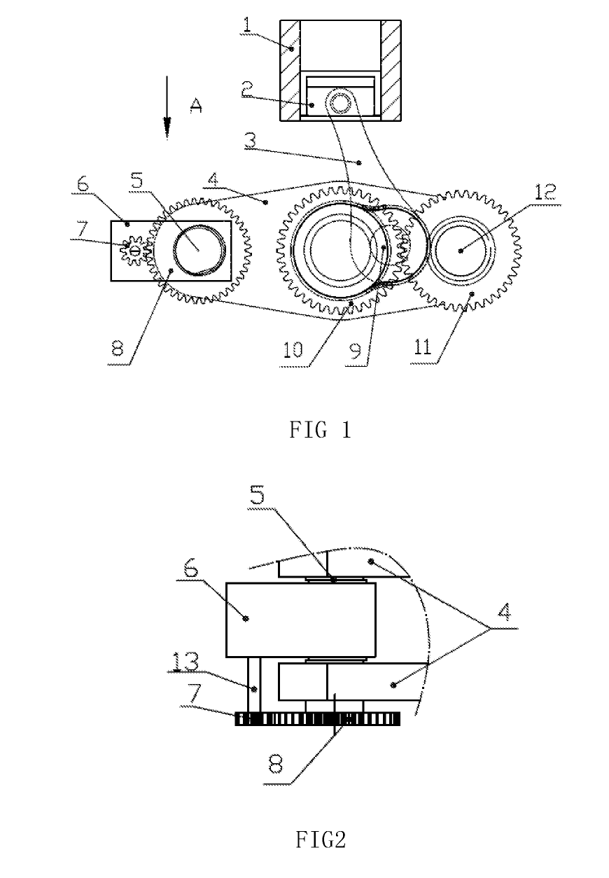

FIG. 1 is an overall structural diagram of the present invention; FIG. 2 is an A-direction partial view in FIG. 1. As shown in FIG. 1 and FIG. 2, the present invention provides an engine with variable compression comprising a cylinder cover, a cylinder body 1, a crankshaft box and a power output shaft 12. The cylinder cover is fixed on the cylinder body 1, and the crankshaft box and the cylinder body 1 are formed into an integral body. In the cylinder body 1, a piston 2 is connected with a crankshaft 9 via a connecting rod 3, the power output shaft 12 is mounted on the crankshaft box. A power output gear 11 and a input gear 10 engaging each other are mounted on the power output shaft 12 and the crankshaft journal 9 respectively. Further provided in the crankshaft box is a supporting arm 4, onto which the crankshaft 9 is mounted, and one end of which is hinged on the cylinder body 1 with the power output shaft 12 used as the hinging axis. The other end of the supporting arm is a control end connected with a rotation control mechanism which makes the supporting arm 4 rotate around the power output shaft 12.

As shown in FIG. 1 and FIG. 2, the rotation control mechanism in this embodiment comprises a control motor (Not shown in the drawing), a control motor gear 7, an eccentric shaft 5, a sliding block 6 and an eccentric shaft gear 8. The control motor is mounted outside the crankshaft box, and the control motor gear is mounted on the sliding block via a motor shaft 13. The eccentric shaft gear 8 is mounted on the center line at one end of the eccentric shaft 5 permanently engaging with the control motor gear 7; The sliding block 6 is connected on the center line at another end of the eccentric shaft 5, and the control end of the supporting arm 4 is hinged on the offset-center line of the eccentric shaft 5. The control motor is mounted outside of the cylinder body and is a permanent-magnet stepper motor. When the control motor drives the eccentric shaft 5 to rotate to a certain angle, the offset-center line of the eccentric shaft 5 drives the supporting arm 4 to move for a certain distance around the hinge point between the supporting arm 4 and the crankshaft box. According to the principle of leverage, the center of the crankshaft 9, which is mounted at the center of bearing arm 4, also moves for a certain distance. In this embodiment, the eccentricity of the eccentric shaft 5 is 2 mm, that is to say, the offset between the center line and the offset-center line of the eccentric shaft is 2 mm, which, by means of the leverage, makes the center of crankshaft 9 move up or down by 1 mm and causes the compression ratio ranges between 8:1 and 20:1. More specifically, when the eccentric shaft gear 8 rotate to make the offset-center line of the eccentric shaft under the center line of the eccentric shaft in maximum stroke, the center of the crankshaft 9 has moved downward by 1 mm, and the center of the crankshaft 9 moves downward by 1 mm relative to the center of cylinder 1 making the volume of the combustion chamber above the cylinder 1 increase by 1 mm×cylinder cross-sectional area, and the compression ratio becomes the minimum by then, 8:1 in this embodiment. When the eccentric shaft gear 8 rotate to make the offset-center line of the eccentric shaft above the center line of the eccentric shaft in maximum stroke, the center of the crankshaft 9 has moved upward by 1 mm (moved by 2 mm as compared with when the eccentric shaft gear reaches the lowest maximum stroke), the center of the crankshaft 9 move upward by 1 mm relative to the center of the cylinder 1 (moved by 2 mm as compared with when the eccentric shaft gear reaches the lowest maximum stroke), then the volume of the combustion chamber of the cylinder 1 reduces by 1 mm×cylinder cross-sectional area (reduces by 2 mm×cylinder cross-sectional area as compared with when the eccentric shaft gear reaches the lowest maximum stroke), and the compression ratio becomes the maximum by then, namely 20:1.

According to prior art, the crankshaft 9 is fixed in the crankshaft box, therefore the front end of the crankshaft extending out of the crankshaft box via the main journal is used as the output shaft of the engine. In this embodiment, because the center of the crankshaft 9 has to be able to move, its front end cannot extend out of the crankshaft box and directly act as the output shaft, it is necessary to provide a power output shaft 12 additionally in the crankshaft box, and the output shaft should be mounted on the crankshaft box, with one of its ends extending out of the crankshaft box. An output gear 11 is mounted on the output shaft engaging with a power input gear 10 mounted on the journal of the crankshaft 9. In this embodiment, the power output shaft 12 also acts as the hinge point of the supporting arm 4.

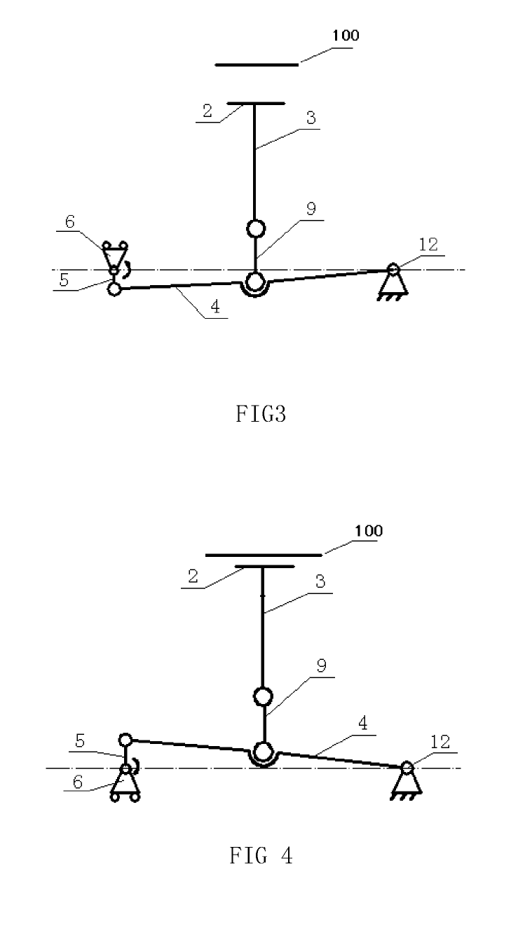

FIG. 3 and FIG. 4 illustrate the operational principle the present invention. As shown in FIG. 1 and FIG. 2 in combination with FIG. 3 and FIG. 4, the operation process of the present invention is described as follows: The external cylindrical surface of the piston 2 is housed in the cylinder of the cylinder body 1, so that piston 2 can but move up and down along its axial line in the cylinder; The end face of the combustion chamber is represented by reference numeral 100; The piston 2 is connected with the connecting rod 3 at the radial hole in piston 2 with a piston pin, so that the connecting rod 3 may only swing in a plane relative to piston 2, for example, in the plane as shown in FIG. 1; The crank of the crankshaft 9 is attached with the connecting rod 3 with a pin so that the swing amplitude of the connecting rod 3 can only be the length of the crank of the crankshaft 9; The crankshaft 9 is hinged with the supporting arm 4 and can rotate on the supporting arm 4. One end of the supporting arm 4 is hinged with the crankshaft box through a fixing shaft, (In this embodiment, the fixing shaft is the power output shaft 12); the other end of the supporting arm 4 is the control end, which is connected with the sliding block 6 via the eccentric shaft 5. The eccentric shaft gear 8 is mounted on the center of the eccentric shaft 5 and engages with the control motor gear 7; The control motor gear 7 is mounted on the sliding block 6 and moves in synchronization with the sliding block 6; The input gear 10 is fixed on the crankshaft 9, its center overlapping the rotation center of the crankshaft 9, and it engages with the output gear 11 at the same time. The center of the output gear 11 overlaps with the center of the output shaft 12. Being connected with the cylinder body, the output shaft 12 used for outputting the driving power.

FIG. 3 shows the moment when the engine piston just reaches the position of the top dead center (TDC) and the offset-center line of the eccentric shaft 5 rotates to downwardly, by this time, the location of the top dead center of piston 2 is the lowest, so the combustion chamber of engine has the maximum volume, and the compression ratio of the engine becomes the minimum. When it is necessary to adjust the compression ratio, the control motor is controlled to make counterclockwise rotation; the offset-center line of the eccentric shaft gradually elevates and thus drives the supporting arm 4 to make upward movement. As a result, the crankshaft 9 also moves upward synchronously and thus drives the control end of the supporting arm 4 to rotate counterclockwise around the power output shaft 12 as the center, and the center of the crankshaft 9 also rotates synchronously and elevates, consequently, the crankshaft 9, the connecting rod 3 and piston 2, as a whole, move upward relative to the cylinder body 1. When the position of the offset-center line of the eccentric shaft 5 moves to right above, the crankshaft 9, the connecting rod 3 and piston 2, move to the highest point relative to the cylinder body 1, consequently, the top dead center of piston 2 also reaches the highest point. At this moment, the volume of combustion chamber is the smallest, and thus the compression ratio of engine reaches the maximum. As shown in FIG. 4, when it is necessary to reduce the compression ratio, the control motor is reversely rotated, so that the offset-center line of the eccentric shaft 5 moves downward, namely, and the top dead center of piston 2 also synchronously moves downward, and thus the compression ratio decreases accordingly. The distance between the center of the eccentric shaft 5 and the center of power output shaft 12 changes along with the rotation of the eccentric shaft 5, and such a distance variation is compensated by the synchronous left-to-right sliding of the sliding block 6. In addition, since the center of the crankshaft 9 varies along with the adjustment of compression ratio, a pair of gears (i.e. the input gear 10 and the output gear 11) is provided for a transition of the power output. As a result, the driving power output is transfer from the crankshaft, of which the center position is subject to variation, to the output shaft 12, of which the center position remains fixed.

Although this embodiment employs the rotation of an eccentric shaft to drive the up-down movement of the supporting arm so that the distance changes between the crankshaft center and the cylinder and the subsequent changes of the volume of the engine combustion chamber correspondingly achieves the purpose of changing the compression ratio of the engine; other structures may be used to enable and control the up-down movement of the bearing arm as recited in this embodiment move. For example, a cam may be used as such a substitute. When a cam rotates under the action of an external force, its external edge is also capable of driving the up-down movement of the bearing arm.

Finally it must be mentioned as follows: said embodiment is merely used to describe rather than limit the present invention; Although the detail description of the present invention is provided with reference to preferred embodiments, those skilled in the art should understand that all the modifications or equitable substitutions to the present invention without deviation from the spirit and range of present invention shall be covered by the claims of present invention.

1. An engine with variable compression comprising a cylinder cover, a cylinder body (1), a crankshaft box and a power output shaft (12), the cylinder cover is fixed on the cylinder body (1), and the crankshaft box is formed with the cylinder body (1) integrally; in the cylinder body (1), a piston (2) is connected with a crankshaft (9) via a connecting rod (3), the power output shaft (12) is mounted on the crankshaft box, a power output gear (11) is placed on the power output shaft (12), an input gear (10) is placed on a crank journal of the crankshaft 9, the power output gear (11) engages with the input gear (10); characterized in the following: a supporting arm (4) is placed in the crankshaft box, the crankshaft (9) is hinged on the supporting arm (4), one end of the supporting arm (4) is hinged on the crankshaft box, and the hinging shaft is the power output shaft (12), the other end of the supporting arm (4) is a control end, the control end is connected with a rotation control mechanism which can make the supporting arm (4) rotate around the power output shaft (12).

2. The engine with variable compression of claim 1, characterized in the following: the rotation control mechanism comprises a control motor, a control motor gear (7), an eccentric shaft (5), a sliding block (6) and an eccentric shaft gear (8); the control motor gear (7) is mounted on the sliding block (6); the eccentric shaft gear (8) is mounted on the center line at one end of the eccentric shaft (5) and always guarantees the engagement with the control motor gear (7); the sliding block (6) is connected on the center line at another end of the eccentric shaft (5); the offset-center line of the eccentric shaft (5) is hinged with the control end of the supporting arm (4).

3. The engine with variable compression of claim 2, characterized in the following: the control motor is mounted outside the cylinder body.

4. The engine with variable compression of claim 3, characterized in the following: the control motor is a permanent-magnet stepper motor.

5. The engine with variable compression of claim 2, characterized in the following: the eccentricity of the eccentric shaft (5) is 2 mm.
